(19) United States
(12) Patent Application Publication
(10) Pub. No.: US 2025/0362735 A1
(43) Pub. Date: Nov. 27, 2025

(54) IMMERSIVE SYSTEM AND DISPLAYING METHOD

(71) Applicant: HTC Corporation, Taoyuan City (TW)

(72) Inventors: Zhong Zhen WU, Taoyuan City (TW); Chen-Si DAI, Taoyuan City (TW); Han Hsiung KE, Taoyuan City (TW)

(21) Appl. No.: 18/942,752

(22) Filed: Nov. 10, 2024

Related U.S. Application Data
(60) Provisional application No. 63/652,049, filed on May 26, 2024.

(51) Int. Cl. G06F 3/01; G06T 7/73

(52) U.S. Cl. CPC G06F 3/011; G06T 7/74; G06T 2200/24; G06T 2207/30196

(57) ABSTRACT

An immersive system includes a tracking device and a head-mounted display device. The tracking device is configured to generate pose data. The head-mounted display device includes a displayer, a communication circuit and a processing circuit. The displayer is configured to display an immersive content. The communication circuit is configured to establish a wireless connection to the tracking device. In response to the wireless connection being established between the tracking device and the head-mounted display device, the processing circuit is configured to compute an appropriate hand position without referring to the pose data. The processing circuit is configured to render a virtual model in the immersive content based on the appropriate hand position prior to stabilization of the pose data received from the tracking device. The processing circuit is configured to correct or determine the virtual model based on the stabilized pose data.

### RELATED APPLICATIONS

This application claims the priority benefit of U.S. Provisional Application Ser. No. 63/652,049, filed May 26, 2024, which is herein incorporated by reference.

### BACKGROUND

### Field of Invention

The present invention relates to immersive systems, and more particularly, to methods and systems for improving the user experience by rendering virtual models immediately upon connection to a tracking device, prior to the stabilization of the tracking device's position data.

### Description of Related Art

Immersive systems, such as Virtual Reality (VR), Augmented Reality (AR), Substitutional Reality (SR), and/or Mixed Reality (MR) systems, are developed to provide immersive experiences to users. When a user wearing a head-mounted display (HMD) device, the visions of the user will be covered by an immersive content (e.g., a virtual world in an outer space) shown on the head-mounted display device. While the user wearing the head-mounted display device, the user may hold handheld controllers in their hands and manipulate the handheld controller for interacting with virtual objects in the immersive content.

Immersive systems require synchronization between head-mounted display devices and tracking devices to generate immersive experiences. Typically, when a head-mounted display device connects to a tracking device, a stabilization period is necessary for the tracking device to determine its exact position and orientation. This stabilization phase introduces a delay, often resulting in a less satisfactory user experience as users wait for visual models to render accurately on their screens.

Existing approaches necessitate this wait, leading to time differences between the connection event and the actual display of the rendered model. Consequently, this latency can diminish the user's sense of immersion and responsiveness, which are critical for optimal VR experiences.

### SUMMARY

The disclosure provides an immersive system, which includes a tracking device and a head-mounted display device. The tracking device is configured to generate pose data about the tracking device. The head-mounted display device includes a displayer, a communication circuit and a processing circuit. The displayer is configured to display an immersive content. The communication circuit is configured to establish a wireless connection to the tracking device. The processing circuit is coupled to the displayer and the communication circuit. In response to the wireless connection being established between the tracking device and the head-mounted display device, the processing circuit is configured to compute an appropriate hand position in front of the head-mounted display device without referring to the pose data. The processing circuit is configured to render a virtual model in the immersive content corresponding to the tracking device based on the appropriate hand position prior to stabilization of the pose data received from the tracking device. The processing circuit is configured to correct or determine a position and an orientation of the virtual model in the immersive content based on the pose data received from the tracking device in response to that the pose data has stabilized.

The disclosure provides a displaying method, suitable for displaying a virtual model. The displaying method includes following steps. A wireless connection is established between a tracking device and a head-mounted display device. Pose data generated by the tracking device is transmitted to the head-mounted display device via the wireless connection. An appropriate hand position in front of the head-mounted display device is computed without referring to the pose data. A virtual model corresponding to the tracking device is rendered based on the appropriate hand position prior to stabilization of the pose data received from the tracking device. A position and an orientation of the virtual model is corrected or determined based on the pose data received from the tracking device in response to that the pose data has stabilized.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an immersive system according to some embodiments of the disclosure.

FIG. 2 is a flowchart illustrating a displaying method according to some embodiments of the disclosure.

FIG. 3A is a schematic diagram illustrating the immersive system while computing the appropriate hand position in some embodiments.

FIG. 3B is a schematic diagram illustrating an image captured by the camera of the head-mounted display device in some embodiments.

FIG. 4 is a flowchart illustrating some sub-steps for computing the appropriate hand position in some embodiments.

FIG. 5 is a schematic diagram illustrating an immersive content displayed by the displayer prior to stabilization of the pose data in some embodiments.

FIG. 6 is a schematic diagram illustrating an immersive content displayed by the displayer after the stabilization of the pose data in some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

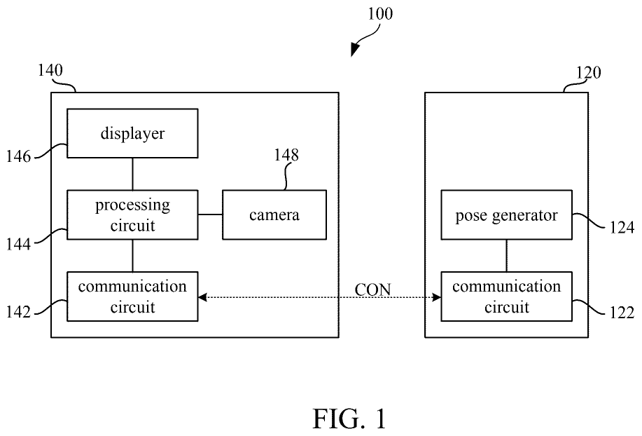

Reference is made to FIG. 1, which is a schematic diagram illustrating an immersive system 100 according to some embodiments of the disclosure. As shown in FIG. 1, the immersive system 100 includes a tracking device 120 and a head-mounted display (HMD) device 140. In some embodiments, the immersive system 100 can be a Virtual Reality (VR), Augmented Reality (AR), Substitutional Reality (SR), and/or Mixed Reality (MR) system for providing an immersive experience to a user. While the user wears the head-mounted display device 140, the head-mounted display device 140 may cover visions of the user, such that the user can dive into a virtual world based on an immersive content displayed on the head-mounted display device 140.

As shown in FIG. 1, the tracking device 120 can be utilized as an input controller regarding to the immersive system 100. In some embodiments, the user may hold the tracking device 120 in his/her hands as a hand-held controller, and the user may manipulate the tracking device 120 for interacting with virtual objects in the immersive content. In some other embodiments, the tracking device 120 can be a wearable tracker. For example, the wearable tracker can be a wristband or a watch worn on user's wrist. In some other embodiments, the tracking device 120 can be a tracking attachment. For example, the tracking attachment can be attached on a wristband or a watch worn on user's wrist.

As shown in FIG. 1, the tracking device 120 includes a communication circuit 122 and a pose generator 124. The communication circuit 122 is coupled with the pose generator 124. When the tracking device 120 is activated or enabled, the communication circuit 122 is configured to establish a wireless connection CON between the tracking device 120 and the head-mounted display device 140. In addition, when the tracking device 120 is activated or enabled (e.g., the user waves his/her hand to wake up the tracking device 120, or the user presses a button or pull a trigger on the tracking device 120), the pose generator 124 is configured to detect pose data POS of the tracking device 120. The pose data POS is able to represent a position (or a displacement over time) and an orientation of the tracking device 120. Since that the tracking device 120 is hold by or attached on user's hand, the pose data generated by the tracking device 120 is able to represent a position, an orientation and a movement of user's hand. When the wireless connection CON is established, the pose data POS (generated by the pose generator 124) can be transmitted by the communication circuit 122 from the tracking device 120 to the head-mounted display device 140 of the immersive system 100.

In some embodiments, the pose generator 124 can be implemented by at least one of an inertial measurement unit (IMU), a motion sensor, an optical tracking sensor, a gyroscope, an accelerometer and a magnetometer for generating the pose data POS. In some embodiments, the communication circuit 122 can be implemented by a Bluetooth transceiver, a BLE transceiver, a WiFi transceiver, a Zigbee transceiver or any similar communication circuit.

In some embodiments, the head-mounted display device 140 includes a communication circuit 142, a processing circuit 144, a displayer 146 and a camera 148. The communication circuit 142 is configured to establish the wireless connection CON to the tracking device 120. In some embodiments, the communication circuit 142 can be implemented by a Bluetooth transceiver, a BLE transceiver, a WiFi transceiver, a Zigbee transceiver or any similar communication circuit. The processing circuit 144 is coupled with the displayer 146, the communication circuit 142 and the camera 148. In some embodiments, the processing circuit 144 can be implemented by a central processing unit, a graphic processing unit, a tensor processor, an application specific integrated circuit (ASIC) or any similar processor.

The displayer 146 is configured to display the immersive content to the user. In some embodiments, the displayer 146 may include one or more display panel(s), lens and/or a panel shifting structure. For example, the immersive content may include a background in an outer space and some relative objects, such as spaceships, aliens, stars or other objects. In some embodiments, when the wireless connection CON is established, the processing circuit 144 is configured to render a virtual object (e.g., a controller, a weapon, a magic stick or a racket) corresponding to the tracking device 120 in the immersive content.

In some embodiments, at the moment that the wireless connection CON is just established and the pose generator 124 is just triggered to generate the pose data POS, the pose data POS in this initial period are not stable.

In some embodiments, the need to wait for the stabilization of pose data from a tracking device is fundamentally rooted in the accuracy and reliability of the immersive content delivered to the user. Pose data POS, which includes the position and orientation of the tracking device 120, is crucial for rendering the virtual environment accurately. When the head-mounted display device 140 first connects to the tracking device 120, the pose data POS in the initial period may be subject to noise and inaccuracies due to various factors such as sensor calibration, sudden movement, or environmental interferences. The pose data POS in the initial time can be erratic and unreliable. Stabilization ensures that the pose data POS has settled into a consistent and accurate state, resulting in smooth and reliable interactions within the immersive environment.

For an immersive experience to be believable, it must be consistent and seamless. If the pose data POS transmitted to the head-mounted display device is utilized immediately (prior to stabilization of the pose data POS) for rendering a virtual model in the immersive content, the head-mounted display device will not able to ensure that the virtual model interacts correctly and responsively with the user's real-world actions. On the other hand, if the head-mounted display device waits for the stabilization of the pose data POS without rendering the virtual model (corresponding to the tracking device) immediately in the immersive content, the user may be confused about this displaying delay, and it ruins the seamless experience.

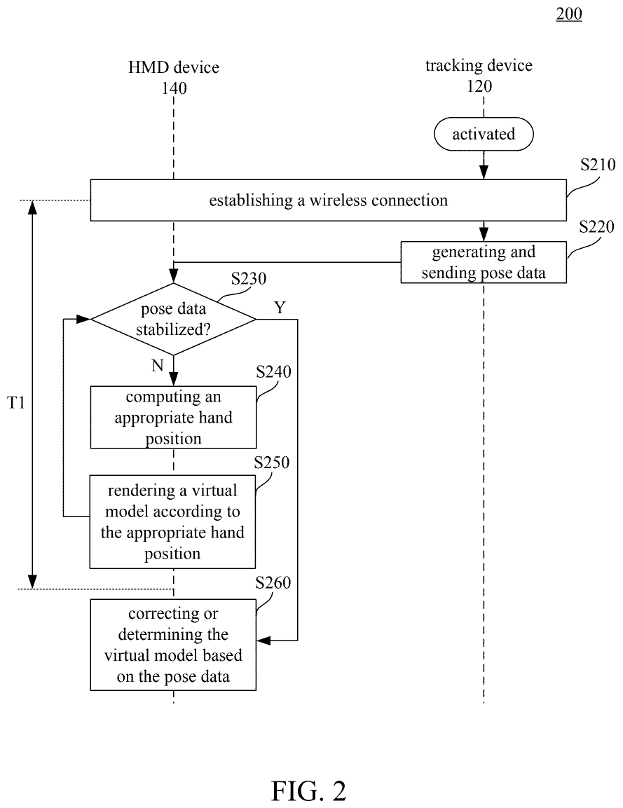

In some embodiments, the immersive system 100 in this disclosure provides a manner to render the virtual model seamlessly and accurately. Reference is further made to FIG. 2, which is a flowchart illustrating a displaying method 200 according to some embodiments of the disclosure. The displaying method 200 can be executed by the immersive system 100 in FIG. 1.

As shown in FIG. 1 and FIG. 2, in response to that the tracking device 120 is activated (e.g., the the user waves his/her hand to wake up the tracking device 120, or the user presses a button or pull a trigger on the tracking device 120) by a user's movement or manipulation, step S210 is executed to establish a wireless connection CON between the tracking device 120 and the head-mounted display device 140. After the tracking device 120 is activated, step S220 is executed to generate the pose data POS by the pose generator 124, and send the pose data POS by the communication circuit 122 of the tracking device 120 through the wireless connection CON to the head-mounted display device 140.

In response to the wireless connection CON is established, the communication circuit 142 is configured to receive the pose data POS from the tracking device 120.

As shown in FIG. 1 and FIG. 2, the processing circuit 144 of the head-mounted display device 140 executes step S230 to determine whether the pose data POS has stabilized.

In one embodiment, as depicted in FIG. 2, the stability of the pose data POS is determined based on whether a predetermined time length T1 (e.g., T1 can be set to 3 seconds) has elapsed since the wireless connection CON was established. When the pose generator 124 of the tracking device 120 is first activated to generate the pose data POS, these pose data POS are initially erratic and unreliable during this initial period (within the predetermined time length T1). The pose data POS fluctuate rapidly as they adjust to correct values, which is why the pose data POS are considered unstable during this initial period. Once the predetermined time length T1 expires, the pose data POS received thereafter are considered stabilized.

In another embodiment, the processing circuit 144 determines the stability of the pose data POS based on the variation in the pose data POS received from the tracking device 120. Initially, the pose data POS is considered unstable. The processing circuit 144 monitors the variation of the pose data POS over a continuous period. If the variation remains below a specified threshold during this continuous period, the processing circuit 144 can then determine that the pose data POS has stabilized.

According to aforesaid embodiments, whether the pose data POS is stable or not can be determined by the expiration of the predetermined time length T1 or determined by the variation of the pose data POS. However, the disclosure is not limited thereto. In some other embodiments, whether the pose data POS is stable or not can be determined by other manners (e.g., a manual input, a computer vision tracking or other equivalent ways).

In response to that the wireless connection CON is established and prior to the stabilization of the pose data POS (i.e., the pose data POS does not stabilize yet), step S240 is executed, by the processing circuit 144, to compute an appropriate hand position in front of the head-mounted display device 140 without referring to the pose data POS.

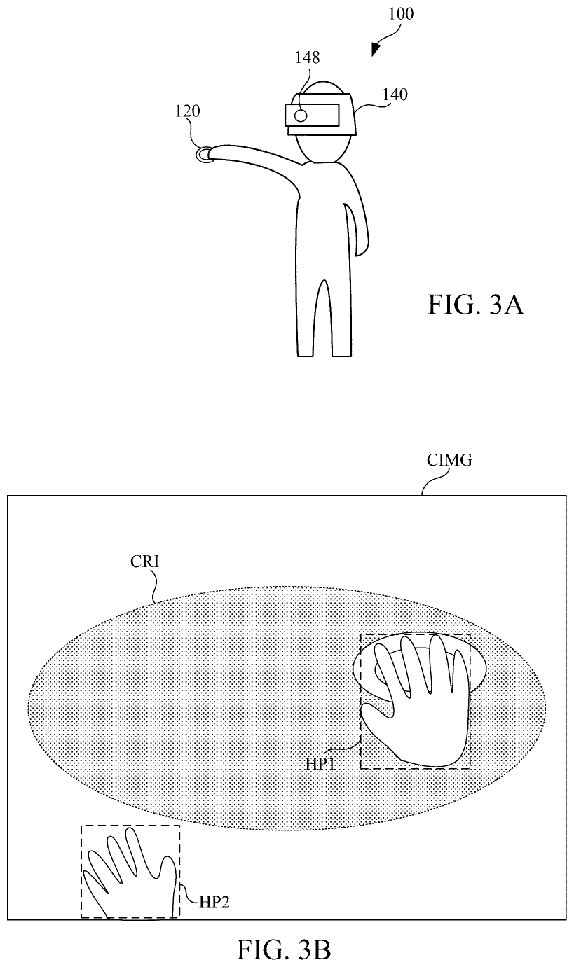

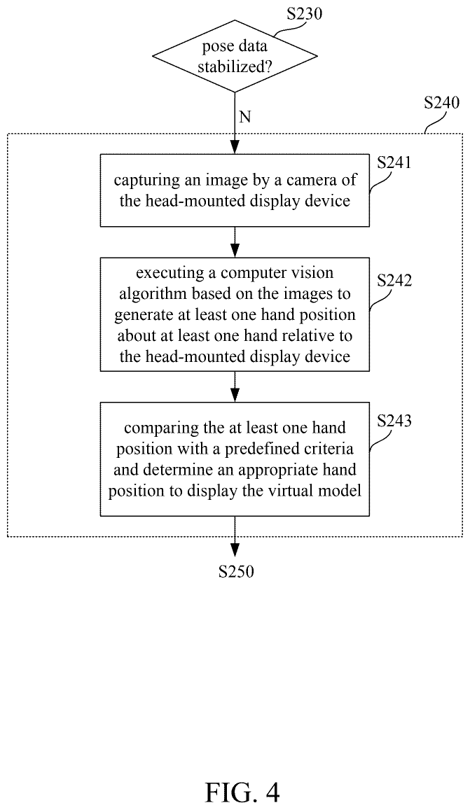

Reference is further made to FIG. 3A, FIG. 3B and FIG. 4. FIG. 3A is a schematic diagram illustrating the immersive system 100 while computing the appropriate hand position in some embodiments. FIG. 3B is a schematic diagram illustrating an image CIMG captured by the camera 148 of the head-mounted display device 140 in step S240. FIG. 4 is a flowchart illustrating some sub-steps for computing the appropriate hand position in step S240.

As shown in FIG. 1, FIG. 3A, FIG. 3B and FIG. 4, the head-mounted display device 140 includes a camera 148. Step S241 is executed, by the camera 148, to capture an image CIMG in front of the head-mounted display device 140. The processing circuit 144 is configured to execute a computer vision algorithm based on the image CIMG for tracking the appropriate hand position.

In some embodiments, as shown in FIG. 3A, the user may move or rotate (e.g., raising, putting down, moving to the right, moving to the left) his/her hands freely. The hand gesture (and also the tracking device 120 hold or attached on the hand) can be detected in the image CIMG. As shown in FIG. 3B, the image CIMG captured by the camera 148 may represent a view in front of the head-mounted display device 140.

In step S242, the processing circuit 144 is configured to execute the computer vision algorithm based on the image CIMG to generate at least one hand position about at least one hand relative to the head-mounted display device 140.

As shown in the FIG. 3B, there are two hand positions HP1 and HP2 detected by the computer vision algorithm based on the image CIMG. The first hand position HP1 indicates user's right hand is raised to an eye level in front of the user. The second hand position HP2 indicates user's left hand is putted down to a waist level of the user. In some embodiments, each of the first hand position HP1 and the second hand position HP2 can be represented by 3DoF (3 dimensional domains of freedom) data about the right/left hand relative to the head-mounted display device 140.

In step S243, the processing circuit 144 is configured to compare the hand positions HP1 and HP2 (detected by the computer vision algorithm) with predefined criteria CRI and determine an appropriate hand position to display the virtual model on.

In some embodiments, the predefined criteria CRI include a positional range to determine the appropriate hand position. In the embodiments illustrated in FIG. 3B, the predefined criteria CRI corresponds to a specific positional range within the image CIMG. As shown in FIG. 3B, because the hand position HP1 matches with the predefined criteria CRI (i.e., the hand position HP1 falls within the specific positional range), the hand position HP1 is regarded as the appropriate hand position. On the other hand, because the hand position HP2 fails to match with the predefined criteria CRI (i.e., the hand position HP2 locates outside the specific positional range), the hand position HP2 is not regarded as the appropriate hand position.

In other embodiments, the predefined criteria CRI include a proximity distance to determine the appropriate hand position. In the embodiments illustrated in FIG. 3B, the hand position HP1 occupying a larger area is closer to the head-mounted display device 140. On the other hand, the hand position HP2 occupying a smaller area is farer from the head-mounted display device 140. In this case, the hand position HP1 (closer to the head-mounted display device 140) is regarded as the appropriate hand position.

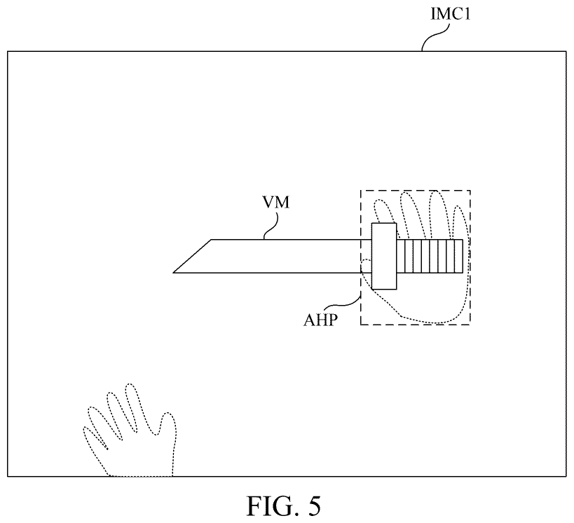

Reference is further made to FIG. 5, which is a schematic diagram illustrating an immersive content IMC1 displayed by the displayer 146 prior to stabilization of the pose data POS in some embodiments.

As shown FIG. 2 and FIG. 5, after the appropriate hand position AHP (e.g., the hand position HP1 in FIG. 3B) is computed in step S240, step S250 is executed, by the processing circuit 144, to render a virtual model VM in the immersive content IMC1 corresponding to the tracking device 120 based on the appropriate hand position AHP. The virtual model VM represents a user interface element that is displayed in response to user interaction. As shown in FIG. 5, the virtual model VM can be a blade hold by an avatar of the user in the immersive content IMC1.

In this case, prior to stabilization of the pose data POS, the virtual model VM can be rendered in step S250 and displayed on the displayer 146. In this case, the user will not experience a displaying delay caused by the stabilization of the pose data POS. The virtual model VM corresponding to the tracking device 120 can be shown in the immersive content IMC1 at the appropriate hand position AHP. In other words, right after the wireless connection CON is established between the tracking device 120 and the head-mounted display device 140, the user is able to see the virtual model VM appeared in the immersive content IMC1, without waiting the stabilization of the pose data POS.

The virtual model VM displayed in the immersive content is optimized to reduce motion sickness by not utilizing the pose data POS to render the virtual model VM, prior to the stabilization of the pose data POS.

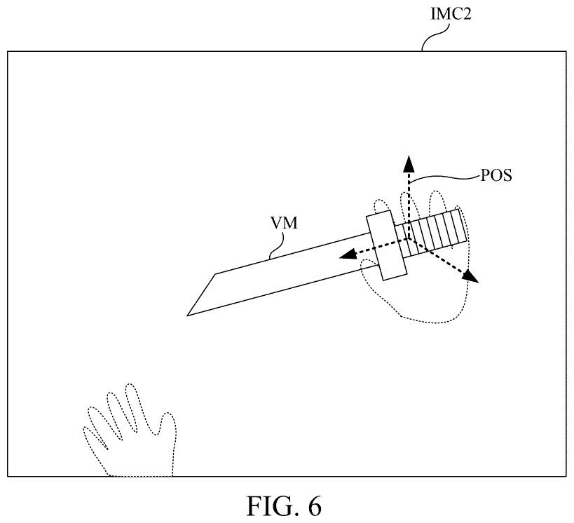

Reference is further made to FIG. 6, which is a schematic diagram illustrating an immersive content IMC2 displayed by the displayer 146 after the stabilization of the pose data POS in some embodiments.

As shown FIG. 2, after the predetermined time length T1 expires, the pose data POS received from the tracking device 120 afterward already stabilize. In other words, the pose data POS are now reliable for tracking the position and orientation of the tracking device 120. As shown FIG. 2 and FIG. 6, step S260 is executed, by the processing circuit 144, to correct or determine a position and an orientation of the virtual model VM in the immersive content IMC2 based on the pose data POS received from the tracking device 120 in response to that the pose data POS has stabilized.

In some embodiments, the pose data POS, generated by the pose generator 124 (e.g., the inertial measurement unit, the motion sensor, the optical tracking sensor, the gyroscope, the accelerometer and the magnetometer), usual have a higher accuracy and a higher refreshing rate in determining the position and the orientation of the tracking device 120 in space, compared to the result of the computer vision algorithm based on the image CIMG. For example, the result of the computer vision algorithm based on the image CIMG is able to update once per second, and the pose data POS generated by the inertial measurement unit is able to update 100 times per second. In step S260, the pose data POS is utilized by the processing circuit 144, to correct) the position and the orientation of the virtual model VM in the immersive content IMC2 as shown in FIG. 6, such that the virtual model VM can be displayed accurately. Stabilized pose data POS helps in correctly aligning the virtual model VM in the immersive content IMC2 with the user's real-world spatial movement. For example, the pose data POS can be added into input data (along with the result of the computer vision algorithm based on the image CIMG) for calculating the position and the orientation of the virtual model VM, such that the position and the orientation of the virtual model VM can be more precise with further reference to the pose data POS.

In some other embodiments, in step S260, the pose data POS can utilized by the processing circuit 144 to determine the position and the orientation of the virtual model VM (e.g., the orientation of the virtual model VM in the immersive content IMC2 can be configured to be aligned with the orientation of the tracking device 120 moving in real world according to the stabilized pose data POS).

This disclosure provides the immersive system 100 and the displaying method 200 for showing rendered models immediately upon establishing a wireless connection CON between the tracking device 120 and the head-mounted display device 140, even before the tracking device's pose data POS stabilizes. By estimating the initial position from hand position and rendering the virtual model VM right away, the immersive system 100 enhances user experience by minimizing latency. Subsequent corrections or determinations of the virtual model VM ensure accuracy as the pose data POS from the tracking device 120 becomes stable, providing a seamless and engaging interaction of the immersive system 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An immersive system, comprising:
a tracking device, configured to generate pose data about the tracking device; and
a head-mounted display device, comprising a displayer, a communication circuit and a processing circuit, the displayer configured to display an immersive content, the communication circuit configured to establish a wireless connection to the tracking device, the processing circuit coupled to the displayer and the communication circuit, the processing circuit configured to:
in response to the wireless connection being established between the tracking device and the head-mounted display device, compute an appropriate hand position in front of the head-mounted display device without referring to the pose data;
render a virtual model in the immersive content corresponding to the tracking device based on the appropriate hand position prior to stabilization of the pose data received from the tracking device; and
correct or determine a position and an orientation of the virtual model in the immersive content based on the pose data received from the tracking device in response to that the pose data has stabilized.

2. The immersive system of claim 1, wherein the head-mounted display device comprises a camera, the camera is configured to capture an image in front of the head-mounted display device, and the processing circuit is configured to execute a computer vision algorithm based on the image to track the appropriate hand position.

3. The immersive system of claim 2, wherein the processing circuit is configured to execute the computer vision algorithm based on the image to generate at least one hand position about at least one hand relative to the head-mounted display device, and the processing circuit is configured to compare the at least one hand position with predefined criteria and determine an appropriate hand position to display the virtual model on.

4. The immersive system of claim 3, wherein the predefined criteria comprises a proximity distance or a positional range to determine the appropriate hand position.

5. The immersive system of claim 1, wherein the tracking device comprises an inertial measurement unit, a motion sensor, an optical tracking sensor, a gyroscope, an accelerometer or a magnetometer for generating the pose data.

6. The immersive system of claim 1, wherein the tracking device is a hand-held controller, a wearable tracker or a tracking attachment.

7. The immersive system of claim 1, wherein whether the pose data has stabilized is determined by the processing circuit according to a variation of the pose data received from the tracking device.

8. The immersive system of claim 1, wherein whether the pose data has stabilized is determined by the processing circuit according to whether a predetermined time length expires since the wireless connection is established.

9. The immersive system of claim 1, wherein the virtual model represents a user interface element that is displayed in response to user interaction.

10. The immersive system of claim 1, wherein the virtual model displayed in the immersive content is optimized to reduce motion sickness by not utilizing the pose data to render the virtual model prior to the stabilization of the pose data.

11. A displaying method, suitable for displaying a virtual model, the displaying method comprising:
establishing a wireless connection between a tracking device and a head-mounted display device;
transmitting pose data generated by the tracking device to the head-mounted display device via the wireless connection;
computing an appropriate hand position in front of the head-mounted display device without referring to the pose data;
rendering a virtual model in an immersive content corresponding to the tracking device based on the appropriate hand position prior to stabilization of the pose data received from the tracking device; and
correcting or determining a position and an orientation of the virtual model based on the pose data received from the tracking device in response to that the pose data has stabilized.

12. The displaying method of claim 11, further comprising:
capturing an image by a camera of the head-mounted display device; and
executing a computer vision algorithm based on the image by a processing circuit of the head-mounted display device to track the appropriate hand position.

13. The displaying method of claim 12, wherein the computer vision algorithm is executed by the processing circuit based on the image to generate at least one hand position about at least one hand relative to the head-mounted display device, the at least one hand position is compared with predefined criteria for determining an appropriate hand to display the virtual model.

14. The displaying method of claim 13, wherein the predefined criteria comprises a proximity distance or a positional range to determine the appropriate hand position.

15. The displaying method of claim 11, wherein the tracking device comprises a motion sensor, an inertial measurement unit, an optical tracking sensor, a gyroscope, an accelerometer or a magnetometer for generating the pose data.

16. The displaying method of claim 11, wherein the tracking device is a hand-held controller, a wearable tracker or a tracking attachment.

17. The displaying method of claim 11, wherein whether the pose data has stabilized is determined according to a variation of the pose data received from the tracking device.

18. The displaying method of claim 11, wherein whether the pose data has stabilized is determined according to whether a predetermined time length expires since the wireless connection is established.

19. The displaying method of claim 11, wherein the virtual model represents a user interface element that is displayed in response to user interaction.

20. The displaying method of claim 11, wherein the virtual model displayed in the immersive content is optimized to reduce motion sickness by not utilizing the pose data to render the virtual model prior to the stabilization of the pose data.
